(19) United States
(12) Patent Application Publication
(10) Pub. No.: US 2010/0053045 A1
(43) Pub. Date: Mar. 4, 2010

(54) ACTIVE MATRIX LIGHT EMITTING DISPLAY DEVICE AND DRIVING METHOD THEREOF

(75) Inventors: David Andrew Fish, Haywards Heath (GB); Nigel David Young, Redhill (GB); Hugo Johan Cornelissen, Eindhoven (NL); Steven Charles Deane, Redhill Surry (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/515,961

(22) PCT Filed: Nov. 21, 2007
(86) PCT No.: PCT/IB07/54734

§ 371 Date: May 22, 2009

(30) Foreign Application Priority Data
Nov. 28, 2006 (EP) 06124879.5

(51) Int. Cl. G09G 3/32

(52) U.S. Cl. 345/82; 345/204

(57) ABSTRACT

An active matrix display device comprises an array of display pixels, each pixel comprising: a current-driven light emitting display element (2); a drive transistor (22) for driving a current through the display element; a storage capacitor (24) for storing a voltage to be used for addressing the drive transistor; and an addressing transistor (16) for coupling data from a data line (6) to the pixel during pixel addressing. The addressing transistor (16) comprises a phototransistor, and the data line (6) is used for external monitoring of the phototransistor. This device design uses a pixel-addressing transistor (16) as the optical feedback element. This addressing transistor is a fundamental requirement of an active matrix-addressing scheme, and its use as a feedback element can therefore avoid any addition pixel complexity to implement an optical feedback function.

### FIELD OF THE INVENTION

This invention relates to an active matrix display device, particularly but not exclusively an active matrix electroluminescent display device having thin film switching transistors associated with each pixel.

### BACKGROUND OF THE INVENTION

Matrix display devices employing electroluminescent, light-emitting, display elements are well known. The display elements may comprise organic thin film electroluminescent elements, for example using polymer materials, or else light emitting diodes (LEDs) using traditional III-V semiconductor compounds. Recent developments in organic electroluminescent materials, particularly polymer materials, have demonstrated their ability to be used practically for video display devices. These materials typically comprise one or more layers of a semi-conducting conjugated polymer sandwiched between a pair of electrodes, one of which is transparent and the other of which is of a material suitable for injecting holes or electrons into the polymer layer.

The polymer material can be fabricated using a CVD process, or simply by a spin coating technique using a solution of a soluble conjugated polymer. Ink-jet printing may also be used. Organic electroluminescent materials can be arranged to exhibit diode-like I-V properties, so that they are capable of providing both a display function and a switching function, and can therefore be used in passive type displays. Alternatively, these materials may be used for active matrix display devices, with each pixel comprising a display element and a switching device for controlling the current through the display element.

Display devices of this type have current-addressed display elements, so that a conventional, analogue drive scheme involves supplying a controllable current to the display element. It is known to provide a current source transistor as part of the pixel configuration, with the gate voltage supplied to the current source transistor determining the current through the display element. A storage capacitor holds the gate voltage after the addressing phase.

FIG. 1 shows the layout of an active matrix addressed electroluminescent display device. The display device comprises a panel having a row and column matrix array of regularly-spaced pixels, denoted by the blocks 1 and comprising electroluminescent display elements 2 together with associated switching means, located at the intersections between crossing sets of row (selection) and column (data) address conductors 4 and 6. Only a few pixels are shown in the Figure. for simplicity. In practice there may be several hundred rows and columns of pixels. The pixels 1 are addressed via the sets of row and column address conductors by a peripheral drive circuit comprising a row, scanning, driver circuit 8 and a column, data, driver circuit 9 connected to the ends of the respective sets of conductors.

The electroluminescent display element 2 comprises an organic light emitting diode, represented here as a diode element (LED) and comprising a pair of electrodes between which one or more active layers of organic electroluminescent material is sandwiched. The display elements of the array are carried together with the associated active matrix circuitry on one side of an insulating support. Either the cathodes or the anodes of the display elements are formed of transparent conductive material. The support is of transparent material such as glass and the electrodes of the display elements 2 closest to the substrate may consist of a transparent conductive material such as ITO so that light generated by the electroluminescent layer is transmitted through these electrodes and the support so as to be visible to a viewer at the other side of the support. Typically, the thickness of the organic electroluminescent material layer is between 100 nm and 200 nm. Typical examples of suitable organic electroluminescent materials, which can be used for the elements are known and described in EP-A-0 717446. Conjugated polymer materials as described in WO96/36959 can also be used.

The most basic pixel circuit has an address transistor, which is turned on by a row address pulse on the row conductor. When the address transistor is turned on, a voltage on the column conductor is used to drive a current source in the form of a drive transistor and a storage capacitor.

In pixel circuits based on polysilicon, there are variations in the threshold voltage of the transistors due to the statistical distribution of the polysilicon grains in the channel of the transistors. Polysilicon transistors are, however, fairly stable under current and voltage stress, so that the threshold voltages remain substantially constant.

The variation in threshold voltage is small in amorphous silicon transistors, at least over short ranges over the substrate, but the threshold voltage is very sensitive to voltage stress. Application of the high voltages above threshold needed for the drive transistor causes large changes in threshold voltage, which changes are dependent on the information content of the displayed image. There will therefore be a large difference in the threshold voltage of an amorphous silicon transistor that is always on compared with one that is not. This differential ageing is a serious problem in LED displays driven with amorphous silicon transistors.

In addition to variations in transistor characteristics there is also differential ageing in the LED itself. This is due to a reduction in the efficiency of the light emitting material after current stressing. In most cases, the more current and charge passed through an LED, the lower the efficiency.

It has been recognized that a current-addressed pixel (rather than a voltage-addressed pixel) can reduce or eliminate the effect of transistor variations across the substrate. For example, a current-addressed pixel can use a current mirror to sample the gate-source voltage on a sampling transistor through which the desired pixel drive current is driven. The sampled gate-source voltage is used to address the drive transistor. This partly mitigates the problem of uniformity of devices, as the sampling transistor and drive transistor are adjacent each other over the substrate and can be more accurately matched to each other. Another current sampling circuit uses the same transistor for the sampling and driving, so that no transistor matching is required, although additional transistors and address lines are required. Current addressing is not preferred, however, as the driver circuitry is more complicated.

There have also been proposals for voltage-addressed pixel circuits which compensate for the aging of the LED material and the pixel circuit components. For example, various pixel circuits have been proposed in which the pixels include a lightsensing element. This element is responsive to the light output of the display element and acts to leak stored charge on the storage capacitor in response to the light output, so as to control the integrated light output of the display during the address period.

FIG. 2 shows one example of pixel layout for this purpose. Each pixel 1 comprises the EL display element 2 and associated driver circuitry. The driver circuitry has an address transistor 16 which is turned on by a row address pulse on the row conductor 4. When the address transistor 16 is turned on, a voltage on the column conductor 6 can pass to the remainder of the pixel. In particular, the address transistor 16 supplies the column conductor voltage to a current source 20, which comprises a drive transistor 22 and a storage capacitor 24. The column voltage is provided to the gate of the drive transistor 22, and the gate is held at this voltage by the storage capacitor 24 even after the row address pulse has ended.

A photodiode 27 discharges the gate voltage stored on the capacitor 24. The EL display element 2 will no longer emit when the gate voltage on the drive transistor 22 reaches the threshold voltage, and the storage capacitor 24 will then stop discharging. The rate at which charge is leaked from the photodiode 27 is a function of the display element output, so that the photodiode 27 functions as a light-sensitive feedback device. It can be shown that the integrated light output, taking into the account the effect of the photodiode 27, is given by:

$${L}_{T} = \frac{{C}_{S}}{{η}_{PD}} ( V ( 0 ) - {V}_{T} ) \qquad [ 1 ]$$

In this equation, η_{PD} is the efficiency of the photodiode, which is very uniform across the display, C_{S} is the storage capacitance, V(0) is the initial gate-source voltage of the drive transistor and V_{T} is the threshold voltage of the drive transistor. The light output is therefore independent of the EL display element efficiency and thereby provides aging compensation. However, V_{T} varies across the display so it will exhibit some non-uniformity.

There are more complicated modifications to this circuit. For example, the drive transistor can be controlled to provide a constant light output from the display element. Reference is made to WO 04/084168. The optical feedback, for aging compensation, is then used to alter the timing of operation (in particular the turning on) of a discharge transistor, which in turn operates to switch off the drive transistor rapidly. This can be thought of as a “snap-off” optical feedback system. The timing of operation of the discharge transistor can also be dependent on the data voltage to be applied to the pixel. In this way, the average light output can be higher than schemes which switch off the drive transistor more slowly in response to light output. The display element can thus operate more efficiently. Such schemes can also compensate for drive transistor threshold variations.

While modifications such as this improve the accuracy of the compensation, they also complicate the pixel design. This is an issue for small pixels, for example the pixels for a small screen as found in mobile products.

There is therefore a need to simplify the pixel design whilst still providing the ability to compensate for the component ageing. This desire has been recognized, and another proposed way to compensate for the ageing of components in the pixel circuit is to provide external sensing of the light output. This can be achieved by integrating a sensor into each pixel, so that the pixel has a drive part and a separate sensor part, which connects to external monitoring lines. The sensor part can for example comprise a photo sensor and a capacitor, with the light output causing the charge on the capacitor to change, and the monitoring function can then measure the charge flow required to reset the state of the capacitor. This removes some of the pixel complexity and transfers it to the external monitoring circuitry. There is still, however, an increase in the complexity of each pixel.

### SUMMARY OF THE INVENTION

According to the invention, there is provided an active matrix display device comprising an array of display pixels, each pixel comprising:

a current-driven light emitting display element;

a drive transistor for driving a current through the display element;

a storage capacitor for storing a voltage to be used for addressing the drive transistor; and

an addressing transistor for coupling data from a data line to the pixel during pixel addressing,

wherein the addressing transistor comprises a phototransistor, and the data line is used for monitoring of the phototransistor.

This device design uses a pixel-addressing transistor as the optical feedback element. This addressing transistor is a fundamental requirement of an active matrix-addressing scheme, and its use as a feedback element can therefore avoid any additional pixel complexity to implement an optical feedback function. This monitoring can be considered to be a test procedure, and enables compensation (i.e. adjustment) of the data to be applied to the pixels during normal use. This can be carried out by circuitry external to the pixel array.

The drive transistor may comprise an n-type transistor, with its source connected to the anode of the light emitting display element and its drain connected to a power line, and with the storage capacitor connected between the gate and source of the drive transistor. This makes the circuit suitable for implementation using amorphous silicon.

In this case, each pixel may further comprise a shorting transistor connected across the drive transistor and controlled by the same control line as the addressing transistor. This enables the anode of the display element to be held at a known voltage during pixel addressing, so that an accurate gate-source voltage can be loaded onto the pixel storage capacitor.

The drive transistor may alternatively comprise a p-type transistor, with its drain connected to the anode of the light emitting display element and its source connected to a power line, and with the storage capacitor connected between the gate and source of the drive transistor. This makes the circuit suitable for implementation using polycrystalline silicon or other technologies.

A charge measurement arrangement can be provided for measuring a charge associated with the phototransistor. This may be carried out at the end of a test cycle. Alternatively, a current measurement arrangement may be used, for measuring a phototransistor current during testing.

The phototransistor may be provided for measuring the light output of that pixel of which the phototransistor forms a part. However, the phototransistor of a pixel may be substantially shielded from the light output of the light emitting display element of that pixel. In this case, the phototransistor is for monitoring the light output from another pixel or pixels. This enables the phototransistor to be outside the pixel aperture, so that it does not need to consume pixel aperture. The phototransistors of a plurality of pixels can be used for monitoring the light output of a pixel under test, the plurality of pixels forming a ring around the pixel under test.

The current-driven light emitting display elements preferably comprise electroluminescent light emitting diode devices, and the display is particularly suitable for use in a portable battery operated device.

The invention also provides a method of driving an active matrix display device comprising an array of display pixels, each pixel comprising a current-driven light emitting display element; a drive transistor for driving a current through the display element and a storage capacitor for storing a voltage to be used for addressing the drive transistor, the method comprising:

storing a pixel drive level in the storage capacitor of a pixel or pixels to be tested using a pixel addressing transistor which couples the pixel to a data line;

during a test procedure, turning on the display element of a pixel or pixels under test, the light output of the pixel or pixels under test illuminating the addressing transistor of a selected pixel or pixels, and causing a charge flow through the addressing transistor of the selected pixel or pixels;

monitoring the charge flow using the data line to determine an illumination level of the pixel or pixels under test; and

deriving pixel correction information for use in the subsequent addressing of the pixel or pixels under test.

This method uses an addressing transistor both for storing pixel data into a pixel storage capacitor and for implementing an optical feedback function. This reduces the pixel complexity.

The addressing transistor of a pixel can be used as a light sensor for that pixel output. In this case, monitoring the charge flow can comprise measuring the charge on the storage capacitor of the pixel under test. The step of storing a pixel drive level in the storage capacitors of a selected pixel or pixels then preferably comprises storing pixel drive levels in all pixels, and turning on the display element of a pixel under test comprises turning on the display elements of all pixels. The test is thus carried out in parallel for all pixels. Measuring the charge on the storage capacitor then comprises measuring the charge stored on all storage capacitors in a sequence.

In an alternative arrangement, the phototransistor of a pixel is substantially shielded from the light output of the light emitting display element of that pixel, and is for monitoring the light output from another pixel or pixels. In this case, the addressing transistors of a plurality of pixels are used as a light sensor for the pixel output of a different pixel under test. This enables the addressing transistor to be outside the pixel aperture. Illumination can then be by means of total internal reflection within a substrate of the display. Monitoring the charge flow can again comprise measuring the charge on the storage capacitors of the selected plurality of pixels.

The charge flow monitoring can instead comprise monitoring a current flowing through the address transistor or transistors of the selected pixel or pixels while the display element of the pixel under test is turned on.

The invention also provides an active matrix display device, comprising an array of rows and columns of display pixels, and a controller for controlling the display device, wherein the controller is adapted to implement the method of the invention. The invention also provides such a display controller.

### BRIEF DESCRIPTION OF THE DRAWINGS

The invention will now be described by way of example with reference to the accompanying drawings, in which:

FIG. 1 shows a known EL display device;

FIG. 2 shows a known pixel design, which compensates for differential aging;

FIG. 3 shows a first example of a pixel circuit of the invention;

FIG. 4 shows a second example of a pixel circuit of the invention;

FIG. 5 shows a third example of a pixel circuit of the invention;

FIG. 6 shows how internal reflection within the substrate can be used to provide a light path between a pixel under test and surrounding pixels;

FIG. 7 shows one possible pattern of pixels used to monitor a pixel under test; and

FIG. 8 shows a display device and controller of the invention.

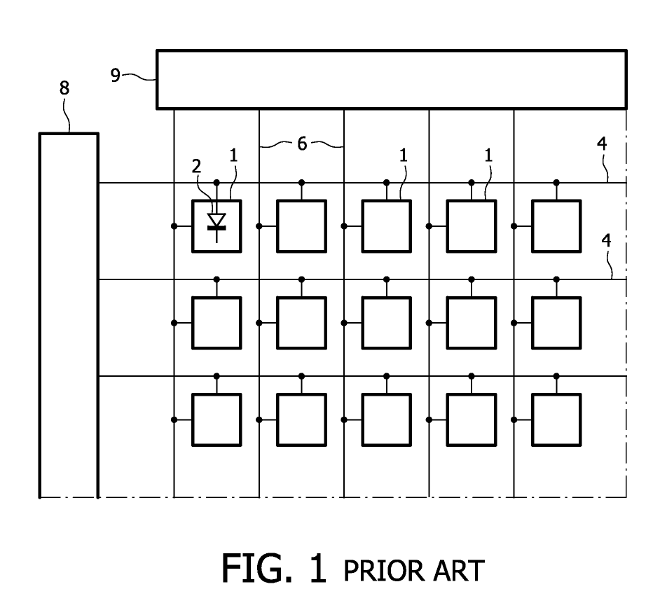

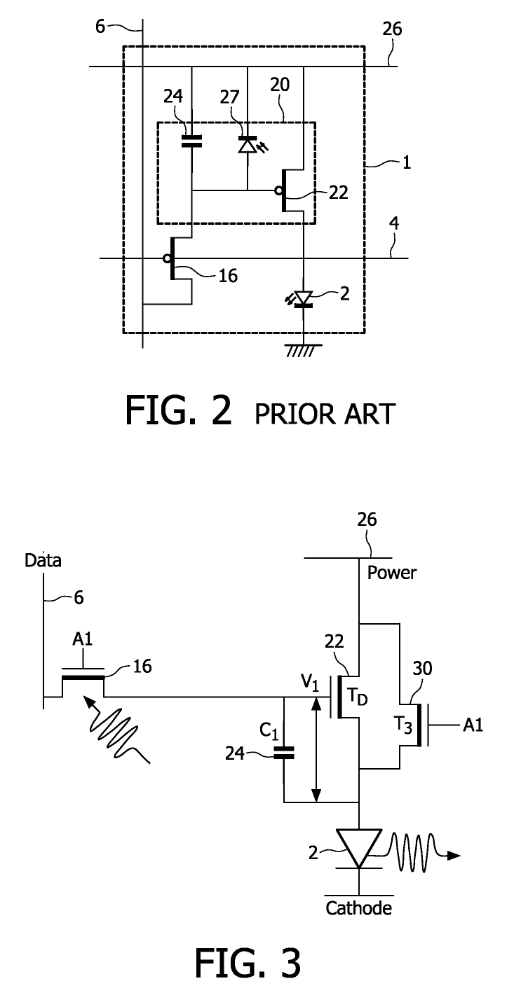

It should be noted that these Figures are diagrammatic and not drawn to scale. Relative dimensions and proportions of parts of these Figures have been shown exaggerated or reduced in size, for the sake of clarity and convenience in the drawings.

### DETAILED EMBODIMENTS

FIG. 3 shows a first example of pixel circuit of the invention, and for implementation using amorphous silicon devices. The circuit has the addressing transistor 16, storage capacitor 24, drive transistor 22 and LED 2 as in a conventional pixel.

The drive transistor comprises an n-type transistor, with its source connected to the anode of the light emitting display element 2 and its drain connected to the power line 26, and with the storage capacitor 24 connected between the gate and source of the drive transistor 22.

The circuit comprises only three TFTs while maintaining an optical feedback functionality. This is achieved by using addressing sequences, which enable the functionality of the TFTs to be shared. In particular, the addressing transistor 16 functions as an optical feedback element as well as a data-loading device.

The reduction of pixel complexity is particularly suitable for mobile device displays with small pixels. Furthermore, such devices enable more complicated drive schemes to be implemented, as the number of rows is not unduly high, so it is possible to trade addressing time for complexity in the pixel.

FIG. 3 also shows a shorting transistor 30 connected across the drive transistor 22 and controlled by the same control line A1 as the addressing transistor 16. This is used in the drive sequence to ensure that an accurate voltage can be stored on the storage capacitor 24.

The addressing sequence is as follows:

(i) The power line 26 is brought low, to a similar potential to the LED cathode (for example ground), to ensure that light emission stops in the whole display.
(ii) The display rows are addressed in sequence to store the data voltage on the capacitor 24. In a test mode, this data voltage can be the same for all pixels. The shorting transistor 30 ensures that the anode of the OLED is charged to the low voltage on the power line, so that the voltage across the storage capacitor 24 is well defined.
(iii) Once all pixels have data stored, all the columns are brought to a low potential, and the power line voltage can be raised. This causes all the pixels to turn on at the same time and emit light.

In one implementation, the address TFT 16 is located under the emitting OLED, so that a photo-leakage results in a decreasing voltage on the storage capacitor 24. In this way, the addressing transistor functions as an optical feedback element for the pixel in which it is located.

The component sizes are arranged so that the photo-leakage does not cause the drive TFT 22 to turn off. Alternatively, the columns could be driven to a more positive voltage, and then the photo-leakage can cause the voltage on the storage capacitor 24 to increase.

(iv) During the next addressing cycle, when the row is pulsed high, the charge on the capacitors 24 can be sensed through the column line 6, before driving the data onto the circuit. In this way, the total light emitted by the circuit can be measured, and by comparing this to a target value, it is possible to correct the column data.

By storing these read out values for at least two input voltage levels, it is possible to determine the TFT and OLED degradation separately.

These values can then be stored, to avoid the need for reading out of the charge every time the display is addressed.

The test procedure can be implemented at intervals short enough that significant drift does not occur. The read operations may for example be only at start up of the display. In one particularly preferred implementation, the test operations can be performed when a mobile device is having its battery re-charged and is therefore connected to mains power source. At this point in time, power consumption is no issue and the display will not be in use. Therefore any required test patterns can be displayed and numerous pixels can be examined at once. The OLED/TFT degradation mechanisms are slow so that a correction at each re-charging period should be sufficient.

The test sequence above is repeated. It will be apparent that the power line can be common to the whole display, so that the pixel circuit does not introduce additional circuit elements or addressing line complexity compared to a most basic active matrix-addressing pixel.

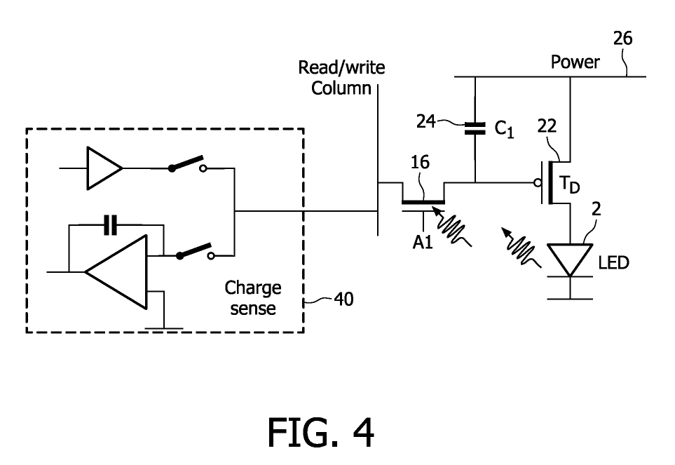

FIG. 4 shows a version of the circuit for a PMOS low temperature polysilicon process, which enables use of a p-type drive transistor 22. This is even simpler, as the shorting transistor is no longer needed, as the use of a PMOS drive TFT 22 changes the location of the storage capacitor 24, so that one end is connected directly to the power line 26, which is the transistor source.

The use of low temperature polysilicon is of particular interest when the display driver circuitry is to be integrated, or partially integrated, onto the display substrate. In a CMOS version, the address TFT can be an n-type device (as shown), but it may be a p-type device.

FIG. 4 also shows the external monitoring circuitry 40 in the form of a charge sensitive amplifier. The drive sequence can be the same as described above.

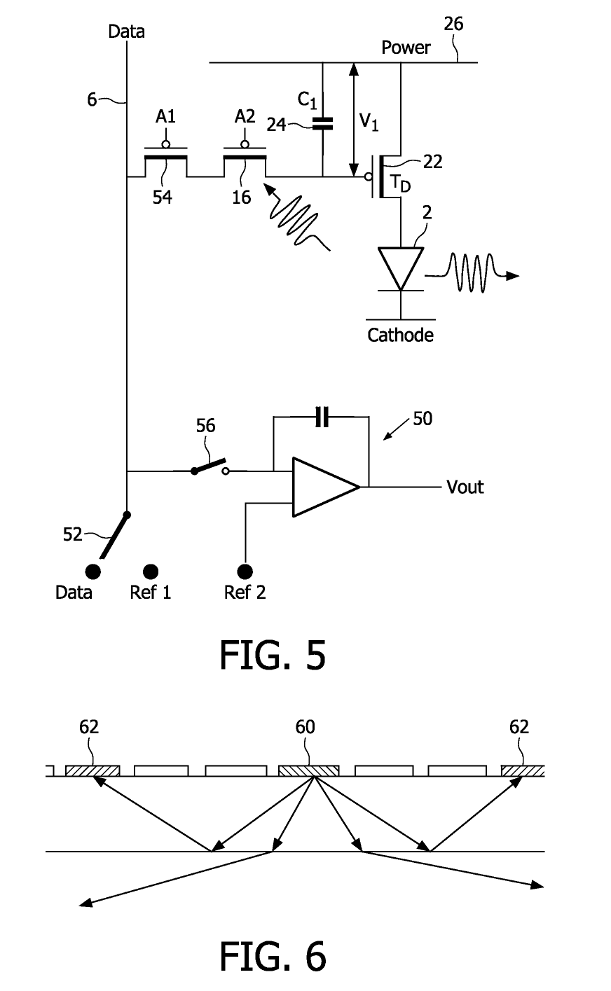

FIG. 5 shows a further possible approach, most suited to low temperature polysilicon and hence shown with p-type transistors, but also possible in amorphous silicon.

In this approach, instead of sensing the charge on the storage capacitor, a photocurrent in a particular selected row can be measured during the emission process itself, namely during the test operation.

FIG. 5 shows the pixel circuit of FIG. 4 connected to a current to voltage converter 50. It also shows the data line 6 switchable between a data source (from a column driver) and a fixed voltage for the current sensing mode of operation. This is shown as switch 52. A reset switch is also shown as 56 for resetting the current to voltage converter, which functions as an integrator.

To enable current sensing during the test procedure, the reverse bias current (minority carrier current) through the phototransistor needs to be read out. The phototransistor needs to be turned off for this measurement, but the current also needs to be able to pass to the column lines for measurement. For this reason, each pixel has two addressing transistors—the phototransistor 16 and a second addressing transistor 54.

The circuit essentially corresponds to the most basic current source pixel circuit with an additional photosensitive addressing transistor placed beneath the light emitting area of the anode.

In normal operation, the switch 52 connects to the data output from the column driver, and the address lines A1 and A2 for the two addressing transistors are switched together to load the data voltage onto the pixel. The cathode can also be switched off during addressing, in a known manner, to avoid power line voltage drops and horizontal cross-talk.

During the measurement phase the following sequence is applied:

(i) Data is loaded onto the entire display in the usual manner. This data may be normal image data, one of a number of plain grey fields, or a set of specific images to be used for the measurement phase.
(ii) After storing the data (closing transistors 54 and 16) the columns 6 are taken to a reference potential, and the current to voltage integrators 50 are reset using switches 52 and 56.
(iii) For a single line, the addressing transistor 54 is turned on, while the phototransistor 16 is kept in the off-state to behave as a photocurrent source. This allows photocurrent to flow down the column and be integrated. The output voltage Vout from the converter 50 is then a function of the actual pixel brightness, and this can be used to correct the data using external circuitry and processing.

Several milliseconds may be needed to integrate low currents (dark greys) as a result of the column capacitances. Ideally measurements will only be made for light greys and white levels. This can be controlled by the test image used.

(iv) The measurement procedure is repeated for the next line, and so on, until every line has been scanned. The data to the entire display (or just to the relevant line) can be refreshed between each line measurement.

It will be appreciated that the leakage currents of the addressing TFTs 54 must be low, or else every pixel in a column will contribute noise to the measurement of a single pixel. Again, measurements at only light grey or white levels may be preferable for this reason. To avoid this problem, a scrolling image could be used (for example a single or low number of lit-up lines), so that the current in the non-selected rows is minimized.

In the event that a single line is scrolled to form the test image, it may also be possible to avoid the use of two addressing transistors, if the dark pixels are set to a low reference voltage so that the off currents are zero.

If cross-talk occurs between neighboring pixels on a row, then point by point measurement can be made, using a scanning dot rather than a scanning line. Of course, this measurement process will take longer. This increase in time may be limited, for example by having multiple scanning points. For example, if cross-talk is only to a nearest neighboring pixel, a ‘checkerboard’, of points could be used.

The optical feedback system will be influenced by light sources other than the pixel of interest, giving rise to errors. These other light sources could be other pixels (optical cross-talk) or ambient light. Both can be more intense than the standard pixel illumination itself and in such situations if no shielding of the phototransistor is used, then it becomes difficult to extract the change in luminance of the OLED from all of the other signals measured by the in-pixel phototransistor.

One solution to the problem of compensating for other light sources influencing the optical feedback is suitable for so-called ‘clam-shell’ or flip type mobile devices. When the device is in standby mode, the main internal display will not be in use and will be in the dark. Therefore optical feedback can be performed one pixel at a time so that the problems of ambient light and cross-talk light are immediately removed. Many mobile devices using an OLED main display are in the form of clam shell devices, as these reduce the time of operation of the main display, which has benefits for OLED displays, which suffer from image burn-in after prolonged periods of use.

There are other ways to compensate for other light sources. For example, ambient light measurement can be carried out to compensate the measured test information and/or the pixel output for the test phase can be increased when there is high ambient light.

The description above is for examples where the phototransistor is used for sensing the light output of the pixel of the same pixel circuit. However, this is not necessarily the case. As explained above, the need for the phototransistor to be illuminated by the pixel output will typically require the phototransistor to be in the pixel aperture. If this can be avoided, the useful pixel aperture can be increased. Furthermore, placing the address transistor under the aperture of the OLED when the display is in use may also cause image artifacts.

If the address TFTs are arranged outside the pixel aperture, when charge sensing is carried out in the standby/re-charge mode, the pixel under test can be examined by surrounding pixels.

Light totally internally reflected from the bottom of the glass substrate can be used for this purpose, and therefore charge is generated in neighboring pixels, as shown in FIG. 6.

FIG. 6 shows a pixel 60 under test having its light output monitored by other pixels 62 by reflection within the device substrate 64. The pixels used for monitoring are sufficiently distant that total internal reflection enables some illumination by the pixel under test.

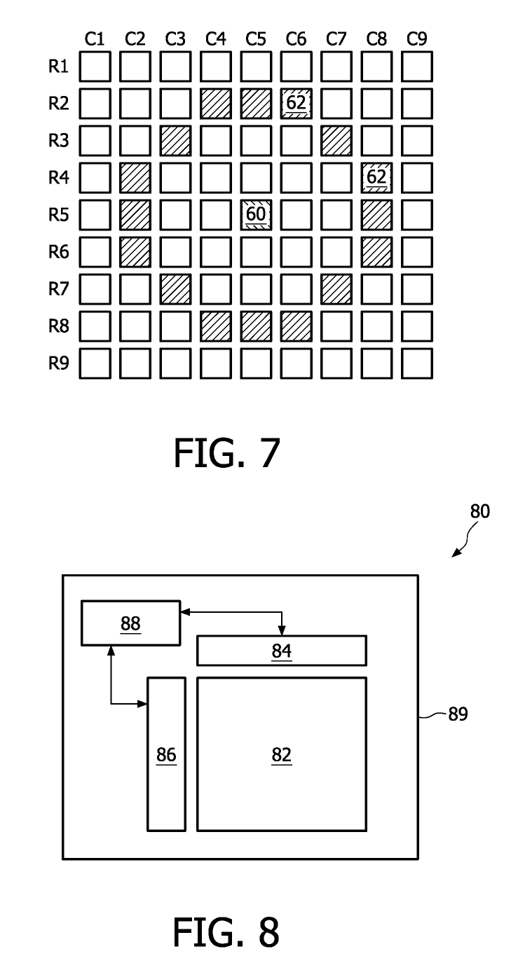

The charge generated in a ring of pixels around the pixel of interest can be read out as shown in FIG. 7. The pixel 60 is the light emitting pixel and the pixel to be examined, all other pixels are off and operating as charge sensing circuits. The columns of the display are held to a fixed low potential when integrating charge, preferably the same potential as the virtual potential provided by the charge sensing amplifier of FIG. 4.

In this case, the off pixels must not start to turn on when charge begins to integrate on the pixel storage capacitors. To ensure this, the off pixels must initially be charged to a sufficiently high voltage before charge integration begins. To maximize the charge readout, the row driver and readout multiplexer should be addressed so that as many readout pixels are connected to the charge integrating amplifier as possible.

In the scheme shown in FIG. 7, rows R2 and R8 would be addressed together along with columns C4,C5,C6 to readout two sets of three pixels into one amplifier. Then rows R3 and R7 would be addressed with columns C3 and C7 for the two more sets of two pixels, and finally rows R4, R5 and R6 would be addressed with columns C2 and C8 for three sets of two pixels. The pixels inside this ring can also be read out to test for background illumination so that appropriate subtractions can also be achieved.

Other blocks of pixels can also be readout at once to improve the amount of charge read from the display.

A readout multiplexer can be used so that only one or a low number of charge integrating op-amps are required for low cost when they are external IC's or for low area when they are integrated onto the glass (for example with LTPS technology).

In this example, each pixel of the display can be measured in this way. The time taken to perform the measurement may be an issue. A QVGA display having 3*320*240=230400 pixels will require about 2.5 hrs to perform the measurement for the whole display where each pixel takes 1/25 of a second for measurement. The device may not always be in standby for this long.

To address this, the last pixel measured is simply memorized as the device comes out of standby and therefore provides the starting point for when the device next goes into standby mode. Also several pixels can be measured at once (to speed up the process) by ensuring that they are well separated so that light from one pixel does not enter the pixel sensor of other pixels already in use as sensors.

It is also possible to alter the readout time to fit an estimated re-charge time period, by reading out a variable number of pixels. If one pixel at a time gives the most accurate measurement (avoiding cross-talk) this may be preferable, but a limited readout time would enable a trade-off between the need for measurement and the accuracy of measurement to be made, thereby defining the number of pixels that should be examined at any one time.

The examples above show common-cathode implementations, in which the anode side of the LED display element is patterned and the cathode side of all LED elements share a common un-patterned electrode. This is the current preferred implementation as a result of the materials and processes used in the manufacture of the LED display element arrays. However, patterned cathode designs are being implemented.

FIG. 8 shows schematically that the display 80 of the invention can be implemented as a display panel 82 having an array of pixels, a row driver 84, a column driver 86 and a controller 88. The controller implements the testing scheme and provides external compensation of the data signals used to drive the display. The display can be part of a portable battery operated device 89.

A number of transistor semiconductor technologies have been mentioned above. Further variations are possible, for example crystalline silicon, hydrogenated amorphous silicon, polysilicon and even semi-conducting polymers. These are all intended to be within the scope of the invention as claimed. The display devices may be polymer LED devices, organic LED devices, phosphor containing materials and other light emitting structures.

The compensation schemes, which can be implemented based on the measured illumination levels have not been described in detail. The way the brightness information can be used to derive a data compensation scheme will be apparent to those skilled in the art. Essentially, the compensation needs to modify the pixel data so that a desired pixel output is reached. The compensation can thus function to modify the drive data in an iterative manner, by selecting compensation values, which tend to bring the actual output towards the desired output. In a more complicated correction scheme, multiple brightness levels for different applied voltages can be analyzed mathematically to calculate the OLED efficiency and drive transistor threshold voltage, in order to calculate a required correction value to be applied to the pixel data.

The same correction rules can be applied as have been proposed in other external correction schemes, and these will be known to those skilled in the art.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. An active matrix display device comprising an array of display pixels, each pixel comprising:
a current-driven light emitting display element (2);
a drive transistor (22) for driving a current through the display element;
a storage capacitor (24) for storing a voltage to be used for addressing the drive transistor (22); and
an addressing transistor (16) for coupling data from a data line (6) to the pixel during pixel addressing
wherein the addressing transistor (16) comprises a phototransistor, and the data line (6) is used for monitoring of the phototransistor.

2. A device as claimed in claim 1, wherein the drive transistor (22) comprises an n-type transistor, with its source connected to the anode of the light emitting display element (2) and its drain connected to a power line (26), and with the storage capacitor (24) connected between the gate and source of the drive transistor.

3. A device as claimed in claim 2, wherein each pixel further comprises a shorting transistor (30) connected across the drive transistor (22) and controlled by the same control line (A1) as the addressing transistor.

4. A device as claimed in claim 1, wherein the drive transistor (22) comprises a p-type transistor, with its drain connected to the anode of the light emitting display element (2) and its source connected to a power line (26), and with the storage capacitor (24) connected between the gate and source of the drive transistor (22).

5. A device as claimed in claim 1, further comprising a charge measurement arrangement (40) for measuring a charge associated with the phototransistor.

6. A device as claimed in claim 1, further comprising a current measurement arrangement (50) for measuring a phototransistor current.

7. A device as claimed in claim 1, wherein the external monitoring of the phototransistor (16) is for testing a pixel, and the phototransistor (16) of a pixel is used as a light sensor for that pixel output during the testing of the pixel.

8. A device as claimed in claim 1, wherein the phototransistor (16) of a pixel is substantially shielded from the light output of the light emitting display element (2) of that pixel, and is for monitoring the light output from another pixel or pixels.

9. A device as claimed in claim 8, wherein the phototransistors (16) of a plurality of pixels (62) are used for monitoring the light output of a pixel under test (60), the plurality of pixels forming a ring around the pixel under test (60).

10. A device as claimed in claim 1, wherein the current-driven light emitting display elements (2) comprise electroluminescent light emitting diode devices.

11. A portable battery operated device (89) including a display device (80) as claimed in claim 1.

12. A method of driving an active matrix display device comprising an array of display pixels, each pixel comprising a current-driven light emitting display element (2); a drive transistor (22) for driving a current through the display element and a storage capacitor (24) for storing a voltage to be used for addressing the drive transistor, the method comprising:
storing a pixel drive level in the storage capacitor (24) of a pixel or pixels to be tested using a pixel addressing transistor (16) which couples the pixel to a data line (6);
during a test procedure, turning on the display element (2) of a pixel or pixels under test, the light output of the pixel under test illuminating the addressing transistor (16) of a selected pixel or pixels, and causing a charge flow through the addressing transistor of the selected pixel or pixels;
monitoring the charge flow using the data line (6) to determine an illumination level of the pixel or pixels under test; and
deriving pixel correction information for use in the subsequent addressing of the pixel or pixels under test.

13. A method as claimed in claim 12, wherein the selected pixel or pixels comprises the pixel under test, such that the addressing transistor (16) of a pixel is used as a light sensor for the pixel output.

14. A method as claimed in claim 13, wherein monitoring the charge flow comprises measuring the charge on the storage capacitor (24) of the pixel under test.

15. A method as claimed in claim 14, wherein storing a pixel drive level in the storage capacitors of a pixel or pixels to be tested comprises storing pixel drive levels in all pixels, and turning on the display element of a pixel or pixels under test comprises turning on the display elements (2) of all pixels, and wherein measuring the charge on the storage capacitor comprises measuring the charge stored on all storage capacitors (24) in a sequence.

16. A method as claimed in claim 12, wherein the selected pixel or pixels (62) comprises a plurality of pixels excluding the pixel under test (60), such that the addressing transistors of a plurality of pixels (62) are used as a light sensor for the pixel output of a different pixel under test (60).

17. A method as claimed in claim 16, wherein the selected plurality of pixels (62) form a ring around the pixel under test (60).

18. A method as claimed in claim 17, wherein monitoring the charge flow comprises measuring the charge on the storage capacitors (24) of the selected plurality of pixels.

19. A method as claimed in claim 12, wherein monitoring the charge flow using the data line (6) comprises monitoring a current flowing through the address transistor (16) or transistors of the selected pixel or pixels while the display element (2) of the pixel under test is turned on.

20. A method as claimed in claim 12, for a portable device (89) having the display (80) in a closable casing, wherein the test is implemented with the casing closed.

21. A method as claimed in 12, further comprising measuring ambient light levels.

22. An active matrix display device (80), comprising an array (82) of rows and columns of display pixels, and a controller (88) for controlling the display device, wherein the controller is adapted to implement a method as claimed in claim 12.

23. A display controller (88) for an active matrix display device, adapted to implement a method as claimed in claim 12.
